(19) United States
(12) Patent Application Publication
(10) Pub. No.: US 2003/0208507 A1
(43) Pub. Date: Nov. 6, 2003

(54) Knowlede driven systems and modus operandi for customer, client and sales transctions

(76) Inventor: Srinivas Venkatram, Mumbai (IN)

Correspondence Address: Rashida A. Karmali, Suite 2525, 230 Park Avenue, New York, NY, 10169, US

(21) Appl. No.: 09/902,280

(22) Filed: Jul. 10, 2001

Related U.S. Application Data
(63) Continuation-in-part of application No. 09/546,704, filed on Apr. 10, 2000, now abandoned.
(60) Provisional application No. 60/242,661, filed on Oct. 23, 2000.
(60) Provisional application No. 60/242,385, filed on Oct. 20, 2000.
(60) Provisional application No. 60/242,389, filed on Oct. 20, 2000.
(60) Provisional application No. 60/242,390, filed on Oct. 20, 2000.

(51) Int. Cl. G06F 7/00

(52) U.S. Cl. 707/104.1

(57) ABSTRACT

The present invention is a unique system for executing sales transaction or personally relevant goal-optimized ordered knowledge, comprising a navigation and user directive system, a set of knowledge structures and engines, a framework for processing data and a framework to organize knowledge mining for a broader practice-community.

### CROSS-REFERENCES TO RELATED APPLICATIONS

This application is a Continuation-in-Part of Provisional Application No. 60/242,661 filed on Oct. 23, 2000, which is a Continuation-in-Part of co-pending applications entitled “Concept Mapping Based Knowledge Acquisition Systems and Methods” (U.S. application Ser. No. 09/546,704 filed on Apr. 10, 2000), “Systems and Methods for Directed Knowledge Management Using the Disha Plafform” (U.S. Application Serial No. 60/242,385), Systems and Methods for Visual Optimal Ordered Knowledge Learning Structures” (U.S. Application Serial No. 60/242,389), and “Systems and Methods for Development of an Interactive Document Cluster Network for Knowledge” (U.S. Application Serial No. 60/242,390) which were filed on Oct. 20, 2000. All five applications are hereby incorporated by reference in their entirety.

### FIELD OF THE INVENTION

The present invention is a unique type of “personalization” technology, which converts information into “personally relevant goal-optimal ordered” knowledge. The invention is also a “knowledge communications tool”, which aims at highly efficient and scalable “transfer of understanding” across communities of practitioners and knowledge systems.

The invention further manages knowledge by characterizing a user's frame of reference in order to direct the user to the Access Intelligence Engine, which delivers “just enough” just-in-time knowledge required. The invention disaggregates information currently organized around the structures embedded in content and reaggregates it around the goal relevant structures employed by individual users in order to achieve their numerous outcomes. The Access Intelligence Engine organizes, orders and delivers optimal meaningful content in response to a specific knowledge request.

### BACKGROUND OF THE INVENTION

The Internet has opened up the opportunity for on-line and low cost worldwide distribution of knowledge and learning materials to users. Almost every single knowledge management initiative, whether in corporate, commercial, educational or personal context attempts at least in part to bring the knowledge base close to the actual tasks being carried out by the user. In other words, the goal is to seek “just-in-time knowledge”. A major challenge lies in making use of Internet technology to deliver highly customized knowledge to each individual user. For example, in the case of customized training, each user should be able to read, interact with and/or download materials, which address the user's needs as a function of the user's current level of learning. Existing systems for collecting and managing information have been inadequate to meet such needs because they do not provide for effective assessing, evaluating and updating of information or knowledge within an organization or system. In other words, existing systems do not adequately address the accrual of knowledge resulting from activity concerning the user's needs as determined from a variety of perspectives, which is an important aspect of succeeding in the electronic global environment. As current information sources become larger and more complex to serve a variety of knowledge workers with particular information needs, providing knowledge workers within an organization with customized packaged knowledge becomes increasingly important to the success of any organization.

One problem lies in the ability of the knowledge workers within the organization to clearly specify their knowledge requirements and the resulting inability of knowledge managers to meaningfully package and provide the appropriate knowledge which may be in the form of documents, information bytes, video or sound, to the knowledge workers. According to the present invention, the problems and disadvantages with existing knowledge management systems and methods have been substantially eliminated.

Another problem also lies first in the ability of the knowledge workers within the organization to clearly specify their knowledge requirements. Second, the overwhelming abundance of knowledge that is available in different forms and the resulting inability of knowledge managers to meaningfully package and provide the appropriate or optimal knowledge which may be in the form of documents, information bytes, video or sound, to the knowledge workers. According to the present invention, the problems and disadvantages with existing knowledge management systems and methods have been substantially eliminated.

One of the critical issues being addressed by managers in large corporations and elsewhere is the issue of capturing, storing and retrieving tacit knowledge. Tacit knowledge includes the experiences, ideas, reactions and suggestions that people have assimilated in their minds or heads and which could be transferred or made available to others in their group, their peers and subordinates within the organization. According to the present invention, the problems and disadvantages with existing knowledge management systems and methods have been substantially eliminated.

### SUMMARY OF THE INVENTION

The present invention is a unique type of “personalization” technology, which converts information into “personally relevant goal-optimal ordered” knowledge. The technology comprises of 4 key input technologies (1) a method to map out or architect a “knowledge use environment”, such that the “outcome space” in which a “goal directed user” operates, is meaningfully and effectively aggregated and presented in the form of a navigation and user directive system (described in concurrently filed patent application entitled “Systems and Methods for Directed Knowledge Management Using the DISHA Platform). (2) a method to translate such outcomes into user-meaningful knowledge structures and the engines to disaggregate information currently organized around the structures embedded in content and reaggregate it around the goal relevant structures employed by individual users in order to achieve their numerous outcomes (described in concurrently filed patent application entitled “Systems and Methods for Visual Optimal Ordered Knowledge Learning Structures). (3) a framework to capture, store, distribute and retrieve data and knowledge across a goal-community (such as a commercial organization) of such goal-directed users (described in concurrently filed patent application entitled “Systems and Methods for Development of An Interactive Document Cluster Network for Knowledge), and (4) a framework to deconstruct information and reconstruct it in terms of user relevant knowledge through a broader practice-community (e.g.:lawyers) specific knowledge organization framework (described in concurrently filed patent application entitled “Concept Mapping Based Knowledge Acquisition System and Methods”).

The present invention comprises of at least three basic components (1) access portals (2) an information addressing system and (3) an access intelligence engine linking to the universe of information.

These components enable the invention to perform the following roles:

a. Enabling end-users of information to sharply specify their requirements and providing a framework for meeting these information requirements in a manner that allows for easy assimilation of that information and its application to a work situation. This is carried out by the Access Portal.

b. Enabling information to be converted into numerous information objects, with each information object being addressed in the specific framework used by Access Intelligence Systems (AIS). This enables creators of content to organize their output into numerous information objects, which are multiply and differently used by different end-users. This is carried out by the Information Addressing System.

c. Enabling different suppliers or sources of information to be connected to various different types of users in a unique manner that allows the right information from the right supplier to reach the right user at the right time, thereby acting as a highly specialized and effective “information exchange”. This is carried out by the Access Intelligence Engine.

Access Portals may be in the form of specialized portals (as described in the preferred embodiment—Sales Multiplier) or in the form of a personal knowledge specifier (as described in the “user centric personal search engine” embodiment of the concurrently filed application entitled “Systems and Methods for Visual Optimal Ordered Knowledge Learning Structures) or in the terms of content navigation interfaces—also called mapping engine—(as described in concurrently filed patent application entitled “Concept Mapping Based Knowledge Acquisition System and Methods), or any other embodiment. The core function is to allow the user to specify knowledge requirements by focusing on their outcomes in the knowledge reconstruction phase described in the frame and also to provide access frameworks which are “modes of thinking” about the information and can deeply influence the choice of documents and knowledge requirements (as described in concurrently filed patent application entitled “Systems and Methods for Directed Knowledge Management Using the DISHA Platform”).

The Information Addressing System contains, knowledge use specification architectures which enable the providers of content to “address” this content appropriately, with the content hub architecture (described in concurrently filed patent application entitled “Systems and Methods for Development of An Interactive Document Cluster Network For Knowledge”), which provides the logic for optimal usage of content inventory by building internal pattern seeking engines that establish best use and optimal sharing paradigms for enabling superior content inventory control and better utilization of knowledge assets. The Information Addressing System also contains the capabilities to enable content builders to define newer communities, provide linkages to content structure architectures that sit with different use platforms.

The Access Intelligence Engines link the knowledge requirements specified by the users, to the appropriate content, and may be in the form of knowledge routers (as described in concurrently filed patent application entitled “Systems and Methods for Visual Optimal Ordered Knowledge Learning Structures”) or in the form of knowledge metalogues that drive the selection of content (as described in concurrently filed patent application entitled “Concept Mapping Based Knowledge Acquisition System and Methods”) or as a knowledge index (described in this patent) or as content hubs in a distributed exchange architecture (described in this patent). Other manifestations perform the basic function of “information brokering” between the specifications built-up by Access Intelligence Systems and various databases of information that can deliver/provide information to the Access Intelligence Systems.

The present invention provides systems and methods for knowledge driven modus operandi and decision-making. These systems and methods comprise of various components including components for optimal data classification, components for relevant inquiry presentation and/or components for interactive delivery of knowledgeable solutions. This system may be deployed in organizations in the following manner: (1) the data already available in the organization or to be made accessible to the user is tagged on the basis of universal classification system. Alternatively, a pattern-seeking engine (also described in concurrently filed patent application entitled “Systems and Methods for Visual Optimal Ordered Knowledge Learning Structures”) may be used. These components will form part of the knowledge service provider which may serve the function of storing and allowing retrieval of appropriate documents that meet the retrieval criteria, (2) the users of the system which may vary in number, role and function (in terms of products, markets, clients, or geography) will each and collectively form part of a personal portal network with each individual having access to the user's own personal portal, (3) the domain context data will be associated with the retrieval engine mechanism which may be located either on the desktop/personal portal, or with the knowledge server or at an intermediate location which can allow some degree of local specification and document choices.

The present invention further describes an access screen framework, said access framework being a powerful paradigm which describes a method of thinking about the problem(s) being encountered and addressed by the user by describing the mode of thinking about the data rather than the data itself, and provides by real intelligence, a choice of documents and knowledge to the seeker of knowledge.

### BRIEF DESCRIPTION OF THE FIGURES

For a complete understanding of the present invention and for further features and advantages thereof, reference is now made to the following description taken in conjunction with the accompanying drawings:

FIG. 1 represents the framework for access intelligence systems.

FIG. 2 represents the components of access intelligence systems with the access portals for accessing knowledge, the information addressing system to “address” new or existing knowledge and access intelligence engine which acts as a router.

FIG. 3 represents the framework for access portals which enable users to sharply define their knowledge needs

FIG. 4 represents the method underlying the development of the access portal development platform

FIG. 5 represents the components of the information addressing system comprising of (A) a content use specification engine, (B) object indexing rule bases and content hub architecture and (C) an object address builder.

FIG. 6 represents the components of the knowledge exchange

FIG. 7 represents the state in the distributed knowledge work environment wherein multiple producers of knowledge work units are available for choice, and multiple buyers are also available for multiple uses of the same knowledge work unit.

FIG. 8 represents the multi-level multi-layered architecture of the distributed knowledge work environment.

FIG. 9 illustrates the entry screen into the personal knowledge portal of a ‘Sales Multiplier’.

FIGS. 10 and 11 represent the display of data selected on the basis of type of document or information category, in the conventional delivery format. This data is retrieved from the sales multiplier knowledge service provider (SM-KSP) by a conventional data retrieval engine.

FIG. 12 provides the subsequent screen when the user decides to access knowledge in the new modus operandi in FIG. 9. In this screen the user selects one of the prospect choices presented, after he has selected his appropriate role.

FIG. 13 illustrates a logical access map structure, presenting the user with a set of options which essentially map out all the issues the sales person will face, and the information he will need to achieve his outcome.

FIG. 14 illustrates the next step of the invention through its deployment of the Visual-OOKS platform described in detail in the co-pending parent application entitled “Systems and Methods for Visual Optimal Ordered Knowledge Learning Structures”. The retrieval engine presents all relevant documents that meet that specific customer situation.

FIG. 15 illustrates one of the documents displayed as a result of the user choosing from the document set offered in FIG. 14.

FIG. 16 illustrates the display screen of a tacit knowledge sharing interface, described in detail in the co-pending application entitled “Systems and Methods for development of an Interactive Document Cluster for Knowledge”.

FIG. 17 illustrates the access screen to knowledge related to an additional step in the sales process. This is related to the choice of sales activity made in FIG. 12 above.

FIG. 18 illustrates a further choice available to the seeker of knowledge which allows for further specification of the user context.

FIGS. 19, 20, 21 and 22 represent the options presented to the user both in terms of hard knowledge and soft data and the consequent displays of documents. These relate to FIGS. 14, 15 and 16 above in a different context.

FIG. 23 represents yet another knowledge access framework such as that described in FIG. 17 above.

### DESCRIPTION OF THE PREFERRED EMBODIMENT

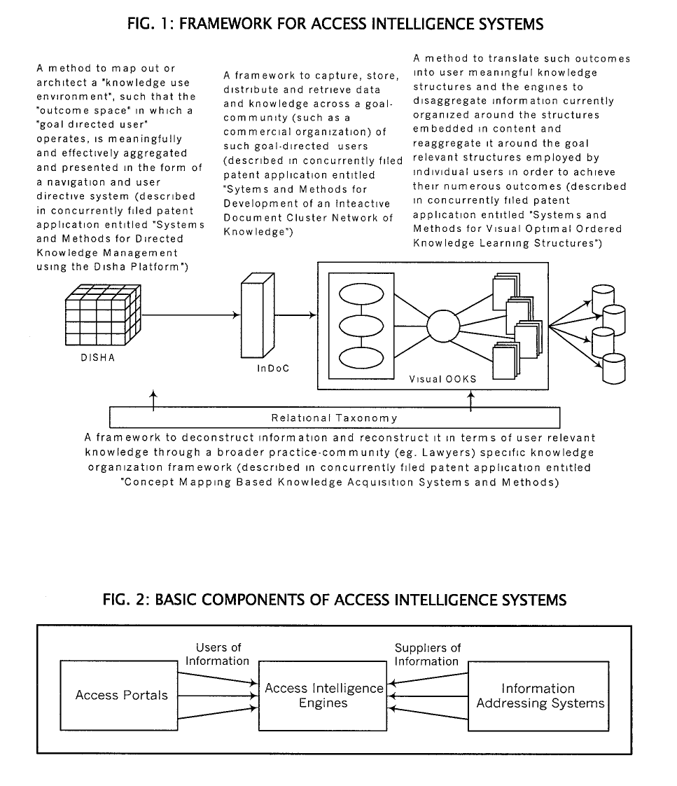

The present invention is a unique type of “personalization” technology, which converts information into “personally relevant goal-optimal ordered” knowledge. The technology comprises of 4 key input technologies (See FIG. 1), (1) a method to map out or architect a “knowledge use environment”, such that the “outcome space” in which a “goal directed user” operates, is meaningfully and effectively aggregated and presented in the form of a navigation and user directive system (described in concurrently filed patent application entitled “Systems and Methods for Directed Knowledge Management Using the DISHA Platform”). (2) a method to translate such outcomes into user-meaningful knowledge structures and the engines to disaggregate information currently organized around the structures embedded in content and reaggregate it around the goal relevant structures employed by individual users in order to achieve their numerous outcomes (described in concurrently filed patent application entitled “Systems and Methods for Visual Optimal Ordered Knowledge Learning Structures”). (3) a framework to capture, store, distribute and retrieve data and knowledge across a goal-community (such as a commercial organization) of such goal-directed users (described in concurrently filed patent application entitled “Systems and Methods for Development of An Interactive Document Cluster Network for Knowledge”), and (4) a framework to deconstruct information and reconstruct it in terms of user relevant knowledge through a broader practice-community (e.g. lawyers) specific knowledge organization framework (described in concurrently filed patent application entitled “Concept Mapping Based Knowledge Acquisition System and Methods”).

The present invention comprises of at least three basic components (1) access portals (2) an information addressing system and (3) an access intelligence engine linking to the universe of information. (See FIG. 2)

These components enable the invention to perform the following roles:

a. Enabling end-users of information to sharply specify their requirements and providing a framework for meeting these information requirements in a manner that allows for easy assimilation of that information and its application to a work situation. This is carried out by the Access Portal.

b. Enabling information to be converted into numerous information objects, with each information object being addressed in the specific framework used by Access Intelligence Systems (AIS). This enables creators of content to organize their output into numerous information objects, which are multiply and differently used by different end-users. This is carried out by the Information Addressing System.

d. Enabling different suppliers or sources of information to be connected to various different types of users in a unique manner that allows the right information from the right supplier to reach the right user at the right time, thereby acting as a highly specialized and effective “information exchange”. This is carried out by the Access Intelligence Engine.

Access Portals may be in the form of specialized portals (as described in the preferred embodiment—Sales Multiplier) or in the form of a personal knowledge specifier (as described in the “user centric personal search engine” embodiment of the concurrently filed patent application entitled “Systems and Methods for Visual Optimal Ordered Knowledge Learning Structures”) or in the terms of content navigation interfaces—also called mapping engine—(as described in concurrently filed patent application entitled “Concept Mapping Based Knowledge Acquisition System and Methods”), or any other embodiment. The core function is to allow the user to specify knowledge requirements by focusing on their outcomes in the knowledge reconstruction phase described in the frame and also to provide access frameworks which are “modes of thinking” about the information and can deeply influence the choice of documents and knowledge requirements. (as described in the concurrently filed patent application entitled “Systems and Methods for Directed Knowledge Management Using the DISHA Plafform”).

The Information Addressing System contains, knowledge use specification architectures which enable the providers of content to “address” this content appropriately, with the content hub architecture (described in concurrently filed patent application entitled “Systems and Methods for Development of An Interactive Document Cluster Network for Knowledge”), which provides the logic for optimal usage of content inventory by building internal pattern seeking engines that establish best use and optimal sharing paradigms for enabling superior content inventory control and better utilization of knowledge assets. The Information Addressing System also contains the capabilities to enable content builders to define newer communities, provide linkages to content structure architectures that sit with different use platforms.

The Access Intelligence Engines link the knowledge requirements specified by the users, to the appropriate content, and may be in the form of knowledge routers (as described in concurrently filed patent application entitled “Systems and Methods for Visual Optimal Ordered Knowledge Learning Structures”) or in the form of knowledge metalogues that drive the selection of content (as described in concurrently filed patent application entitled “Concept Mapping Based Knowledge Acquisition System and Methods”) or as a knowledge index (described in this patent) or as content hubs in a distributed exchange architecture (described in this patent). Other manifestations perform the basic function of “information brokering” between the specifications built-up by Access Intelligence Systems and various databases of information that can deliver/provide information to the Access Intelligence Systems.

Access Portals

The Access Portals are specialized end-user applications, which allow end-users to quickly and accurately specify their information requirements and view this information through the filter of various knowledge frameworks, which describe “modes of thinking” like solution pathways, action paths, and other approaches that define potential usage of the information sought.

Access Portals may also play an additional role of providing end-users of information with an easy to understand and easy to use frameworks which “provoke” thought and encourage the adding of both explicit (documentary), and tacit (soft) knowledge.

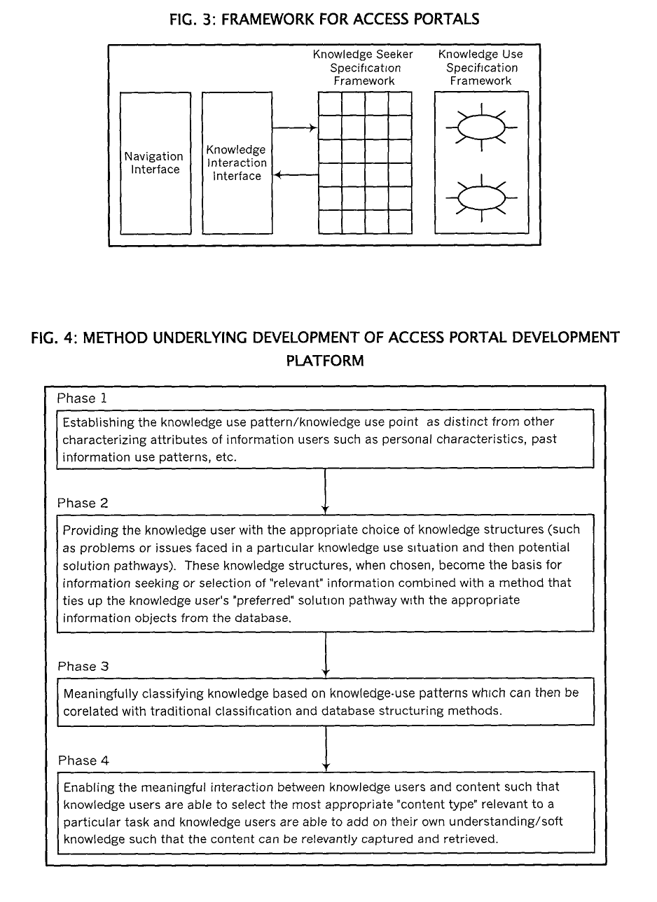

Access Portals comprise of the following sub components (See FIG. 3): (a) A “Knowledge-seeker Specification Framework” (described in the concurrently filed patent application entitled “Systems and Methods for Directed Knowledge Management Using the DISHA Platform”) (b) A “Knowledge-use Specification Framework” that may offered as navigational maps, or may act as content structuring frameworks (described in the concurrently filed patent application entitled “Systems and Methods for Visual Optimal Ordered Knowledge Learning Structures”). (c) The “Knowledge Interaction Interfaces”, which may be provided as component services along with information, or may sit independently as a tacit knowledge management layer (described in the concurrently filed patent application entitled “Systems and Methods for Development of An Interactive Document Cluster Network for Knowledge”).

Access Portal Development Platform

Access Portals may be specifically constructed for different application groups such as sales people in various sectors, or as e-learning systems, or expertise transfer tools, etc. Each of these can be unique knowledge delivery applications, having distinct markets with uniquely organized knowledge specification and delivery frameworks, with further variations across communities of practice such as banking, insurance, segments within health care, civil engineers, doctors, lawyers, etc., and, further customization possibilities for specific organizations or groups of users within each of these communities such as a single corporation, or even a single country location within a corporation in the area of say, insurance.

Access Portals may also be constructed by the individual trained, “Access Portal Programmers”, using the “Access Portal Development Platform”, which is a general programming framework for creation of numerous customized Access Portals for specific communities of all kinds.

The Access Portal Development Platform allows individual knowledge user communities to build unique or highly customized Access Portals meant for their specific needs. The Access Portal Development Platform is built on the following basis:

a. It allows developers to build a portal using a sequence of component construction phases.

b. It provides developers with support infrastructure in the form of Access Intelligence map libraries for specific domains, communities of practice, etc., thereby enabling them to build an appropriate portal for a specific group,

c. It provides developers with the methodologies, standards, and technical support in terms of support software such as templates, tool palettes, etc. associated with software development platforms.

The framework for Access Portal Development (based on concurrently filed patent applications entitled “Systems and Methods for Directed Knowledge Management Using the DISHA Platform” and patent application entitled “Systems and Methods for Visual Optimal Ordered Knowledge Learning Structures”) (See FIG. 3). This is translated into a formal method (See FIG. 4):—which in turn will be implemented by using common software development approaches into a platform.

Information Addressing System

The Information Addressing System contains, knowledge use specification architectures which enable the providers of content to “address” this content appropriately, with the content hub architecture (described in detail in the concurrently filed patent application entitled “Systems and Methods for Development of An Interactive Document Cluster Network for Knowledge”), which provides the logic for optimal usage of content inventory by building internal pattern seeking engines that establish best use and optimal sharing paradigms for enabling superior content inventory control and better utilization of knowledge assets. The Information Addressing System also contains the capabilities to enable content builders to define newer communities, provide linkages to content structure architectures that sit with different use platforms.

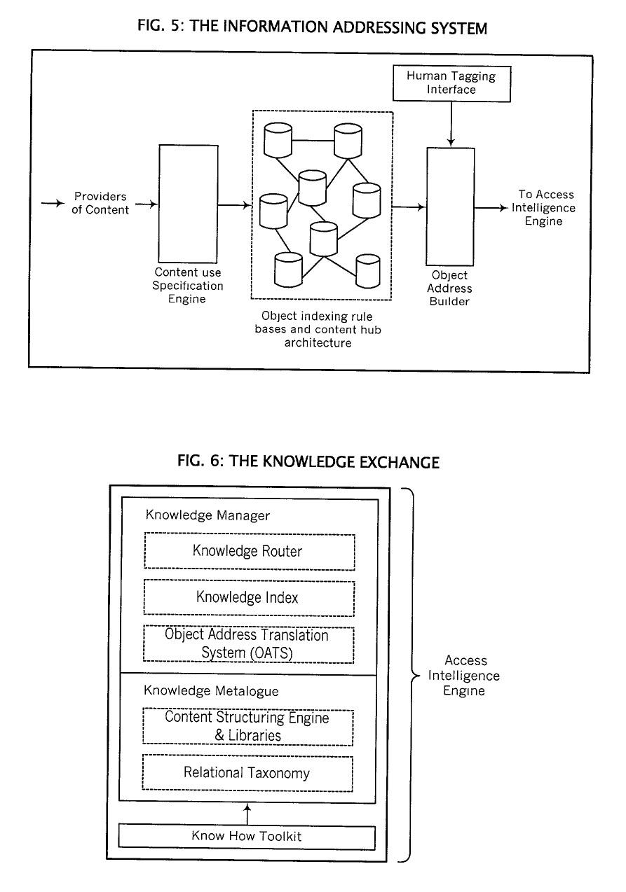

The information addressing system comprises of (A) a content use specification engine, (B) object indexing rule bases and content hub architecture and (C) an object address builder. (See FIG. 5).

(A) The content use specification engine is a formal use specification framework that closely matches the actual information use frameworks, which are defined as part of the Access Portals with the content use frameworks and therefore allows every individual user of knowledge to also become a provider of knowledge such that he/she can ensure that the knowledge created by him/her is utilized by as many of the intended users, at the time they need it, as possible. Content use specification architecture is translated into an alternative construction of navigation maps that, in a sense, present the inverse process described in the mapping engine described in the concurrently filed patent application entitled “Concept Mapping Based Knowledge Acquisition System and Methods” or in the knowledge use specification described in the concurrently filed patent application entitled “Systems and Methods for Directed Knowledge Management Using the DISHA Platform”.

The user identifies the dimensions of sharing, such as dimensions of concern, dimensions of task, dimensions of process, dimensions of interest, etc., which go into building the knowledge architecture of the larger community of practice using this system. (as described in the concurrently filed patent application entitled “Systems and Methods for Development of An Interactive Document Cluster Network for Knowledge”).

These dimensions of sharing are built on the principles of concept organization (described in the concurrently filed patent application entitled “Concept Mapping Based Knowledge Acquisition System and Methods”), organization and knowledge architecture construction (described in the concurrently filed patent application entitled “Systems and Methods for Directed Knowledge Management Using the DISHA Platform”), and sharing of knowledge fragments (described in the concurrently filed patent application entitled “Systems and Methods for Development of An Interactive Document Cluster Network for Knowledge”).

(B) An object indexing rule-base sets up priorities and organizing rules for the co-classification of objects (i.e., if one object within a class is said to have an attribute, then all other information objects are also awarded the same attribute.) This object indexing rule-base may be in the form of a definitional component aiding the object tagging efforts, or may be in the form of active content hubs, which collect, organize, and distribute content for a specific sub community of practice such as process team members in a large organization. Based on the “dimensions of sharing”, the “addressing” is transmitted to all related content hubs.

The Content Hubs (described in the concurrently filed patent application entitled “Systems and Methods for Development of An Interactive Document Cluster Network for Knowledge”) comprise of artificial intelligence rule bases and “knowledge architecture” structures, along with delivery capabilities in terms of content reorganization and information object indexing. These Content Hubs perform the specific function of allowing data fragments, information and content formats, and “intelligent content agents” to be built and shared across communities of practice and enable the meaningful recontextualisation of information from one group of users to another.

(C) Object Address Builder System is the component which “manages” the tagging and addressing “results” that are generated in the course of specification being carried out by various users.

The information addressing may also in some cases, carry additional information about the use of a document (past patterns of use), etc. to enable better selection or prioritization of document offerings to users.

The Object Address Builder System also manages the “cyborg” tagging which involves presenting documents for human intervention or addition to the tags already created by the rule bases.

### EXAMPLE 1

Knowledge Exchange—An Embodiment of the Access Intelligence Technology:

One of the issues facing organizations and communities of practice, is the problem of connecting different suppliers or sources of information, to various different types of users in a unique manner, such that the right information from the right supplier reaches the right user at the right time; i.e. the need for a highly specialized and effective “information exchange”.

Knowledge Exchanges contain access intelligence engines that may be in the form of knowledge routers (as described in the concurrently filed patent application entitled “Systems and Methods for Visual Optimal Ordered Knowledge Learning Structures”) or in the form of knowledge metalogues that drive the selection of content (as described in the concurrently filed patent application entitled “Concept Mapping Based Knowledge Acquisition System and Methods”) or as a knowledge index (described below). Other manifestations perform the basic function of “information brokering” between the specifications built-up by Access Intelligence Systems and various databases of information that can deliver/provide information to the Access Intelligence Systems.

The Knowledge Exchange comprises of two basic components: (A) Knowledge Manager, and (B) the Knowledge Metalogue. Further, the development of the knowledge organization driving the Exchange, is built through a support infrastructure called the KnowHow Toolkit (described in the concurrently filed patent application entitled “Systems and Methods for Development of An Interactive Document Cluster Network For Knowledge”). (See FIG. 6).

(A) The Knowledge Manager performs the function of matching information requests and information providers. It comprises of three components: (i) The Knowledge Router, (ii) The Knowledge Index, (iii) The Object Address Translation System (OATS). These are described below:

i. The Knowledge Router performs the actual function of matching the information request sent by one or more Access Portals, described above, with the information objects supplied by numerous information suppliers (databases, repositories, etc.) through the Information Addressing System (IAS) described above. The knowledge routing function is enabled through the mechanism of a central information brokering protocol, called UCKF (described in the concurrently filed patent applications entitled “Systems and Methods for Visual Optimal Ordered Knowledge Learning Structures” and patent application entitled “Concept Mapping Based Knowledge Acquisition System and Methods”). The Knowledge Router is described in further detail in the concurrently filed patent application entitled “Systems and Methods for Visual Optimal Ordered Knowledge Learning Structures”. To enable this knowledge routing function the Knowledge Router is supported by two key administrative components—the knowledge index and the OATS.

ii. The Knowledge Index is the “authority”, which provides (a) information about the Knowledge Access Portals and information need descriptions, (b) the sources of information and types of information, (c) the information about various repositories and actual storage of information, (d) access to maps and knowledge delivery frameworks for builders of Access Intelligence Portals, and (e) the administrative and support mechanisms for more users to join the Exchange and more suppliers of information to “register” the availability of content and their potential users, in terms of Access Intelligence frameworks.

The Knowledge Index is usually meant for a specific community of users and may, depending upon the size and organization of the community, comprise of multiple Index Hubs (sometimes co-residing with Content Hubs described in the concurrently filed patent application entitled “Systems and Methods for Development of An Interactive Document Cluster Network for Knowledge”). The Knowledge Index performs the critical function of providing “opportunity for matches” between publishers of content and developers or administrators of Access Portals in a community. The Knowledge Index may also perform the additional function of certifying (i) the validity and availability of developmental resources such as Access Maps and Specification Architectures and (ii) usability and performance information on information sources. The Knowledge Index as certifying authority may also allow for continuous evolution of the Knowledge Metalogue and the Taxonomic

relationships and algorithms.

iii. The object address translation system (OATS), which performs the function of translating requests in terms of the unique classification system used by an access intelligence system, into requests from various information sources. The OATS will comprise of one or many classification translation libraries (when requesting for documents stored under traditional classification systems), and/or will use technologies such as XML for “talking” to other information databases, services, etc. The OATS is essentially a schema for providing linkages between the information brokering tag framework (also called the UCKF described in the concurrently filed patent applications entitled “Systems and Methods for Visual Optimal Ordered Knowledge Learning Structures” and “Concept Mapping Based Knowledge Acquisition System and Methods”), and the schemas that describe information objects provided by numerous database services. Some of the schema that the address translation system will build on, or interact with, may include “commonly accepted” information object tagging schema such as those announced by the W3C or e-learning object tagging schema (being developed by the IEEE Consortium), or any other schema that meaningfully define a class of information objects (which could include multiple media files, or software programs libraries, etc.) The OATS may also contain formally created translation tables and rule bases that provide a linkage between Access Intelligence tags and offline library books, media archives, etc. (These are referred to in the concurrently filed patent application entitled “Concept Mapping Based Knowledge Acquisition System and Methods”). Furthermore, the OATS may also contain optimal placement algorithms that provide rules for groups of information objects and their appropriate placement in numerous content structures.

(B) The Knowledge Metalogue enables the Knowledge Exchange to act as a “knowledge creator”, which performs the function of combining various information objects into a “content product”, which best meets the needs of the user.

The Knowledge Metalogue comprises of two components: (i) The Content Structuring Engine and Libraries and (ii) The Relational Taxonomy

i. The Content Structuring Engine and Libraries (CSE) perform the knowledge restructuring function, which involves combining information objects into meaningful content packs or delivery formats. These structures may be embodied in the form of content development formats, content agents, concept organization algorithms, etc. and result in information objects, which are “contextualized” into content packs. (See concurrently filed patent application entitled “Systems and Methods for Visual Optimal Ordered Knowledge Learning Structures” for details on Learning Structures, Concept Organization; and concurrently filed patent application entitled “Systems and Methods for Development of An Interactive Document Cluster Network for Knowledge” for details on Interactive Document Clusters).

ii. The Relational Taxonomy is the master classification system that allows for information objects to be correctly tagged and allows information users to reconstruct knowledge in terms of their own work and decision needs. The Relational Taxonomy is the defining framework, which provides for navigational pathways within the Access Portals and navigation driven content specification in the Content Management System. The Knowledge Metalogue is described in detail in the Relational Taxonomy of the concurrently filed patent application entitled “Concept Mapping Based Knowledge Acquisition System and Methods”).

The Relational Taxonomy is also the core framework for extracting the know-how of a community of users (because it is built on the premise that ‘knowledge is as knowledge is used’). When used as a framework for extracting know-how for say, a community of practice within a large corporation, (for example: metallurgists in a large steel company), the Relational Taxonomy is translated into a formal set of questionnaires, software tools for extracting knowledge heuristics, and a set of algorithms that drive the linkages between solution heuristics, action paths, information frameworks, and various knowledge encounters in the company, such as decisions, actions, etc.

This Relational Taxonomy is embodied in the form of a formal knowledge design architecture for a community of users, which comprises of three components (a) the organization architecture (b) the knowledge use architecture, and (c) the information interaction framework. The knowledge design architecture detailed out in parts in the concurrently filed patent applications entitled “Concept Mapping Based Knowledge Acquisition Systems and Methods” (Relational Taxonomy), “Systems and Methods for Directed Knowledge Management Using The DISHA Platform” (organizational and knowledge architecture), “Systems and Methods for Visual Optimal Ordered Knowledge Learning Structures” (learning structures, concept organization et al), and in concurrently filed patent application entitled “Systems and Methods for Development of An Interactive Document Cluster Network For Knowledge” (content relationship structures).

The KnowHow Toolkit (Described in detail in the KnowHow Toolkit in the concurrently filed patent application entitled “Systems and Methods for Development of An Interactive Document Cluster Network for Knowledge”), acts as the repository for the knowledge structures of the communities of practice and provides support in this area, not only to the Access Intelligence Engine, but also to the developer of Access Portals. These structures may be embodied in the form of content development formats, content agents, concept organization algorithms, etc. and presentation tools, which organize information objects into meaningful patterns and equally important, enable “experts” with a fund of tacit knowledge to communicate or transfer their expertise or identify best practices easily through the same set of tools.

### EXAMPLE 2

Distributed Knowledge Work Environments—A New Paradigm (Embodiment of the Access Intelligence Technology)

A fundamental shift in the organization of work is the movement from the production-distribution model of knowledge work to the mass customization model. In its essence, mass customization implies (1) the disaggregated and highly individual creation of work objects and the numerous configurations of these work objects into multiple designed products that meet specific outcomes within a system. This is mass customization of production (specifically knowledge work of all kinds such as industrial design, law, much of managerial work etc.). The mass customization of knowledge is a central feature of Access Intelligence Technologies, which are also concerned with the second type of mass customization—(2) the mass customization of markets implies the configuration and creation of unique products and services for a market which is being continuously segmented disaggregated and reaggregated in terms of customer needs. The difference here is that the product availability is a given but the users are a continually shifting and transforming set. Such mass customization is a unique feature of the knowledge use situation, where the users (customers) of knowledge are continuously shifting in their needs across time, space and experience. The mass customization of markets is true of any market place or group of customers who are being segmented and aggregated on the basis of a transforming set of needs, e.g.: the business learning market.

This embodiment of the access intelligence technology aims to create two way mass customization in the knowledge work environment. On one hand, there are numerous creators of knowledge products (even a simple financial report has a number of inputs, each of which may appear as a data point in the final report, but is actually the product of a sequence of knowledge work such as calculations, referring to documents etc. which may be fruitfully performed by experts or low cost out sourcing services. Each of these sequences is one of the knowledge products referred to above.) These knowledge products are both end products and inputs into other knowledge products. It is possible therefore, to create a marketplace where such products are available, or the required competencies and skills are made available such that large scale out sourcing of numerous relatively simple, but time and labor intensive knowledge components can be created by different knowledge workers and configured into different combinations by other knowledge workers.

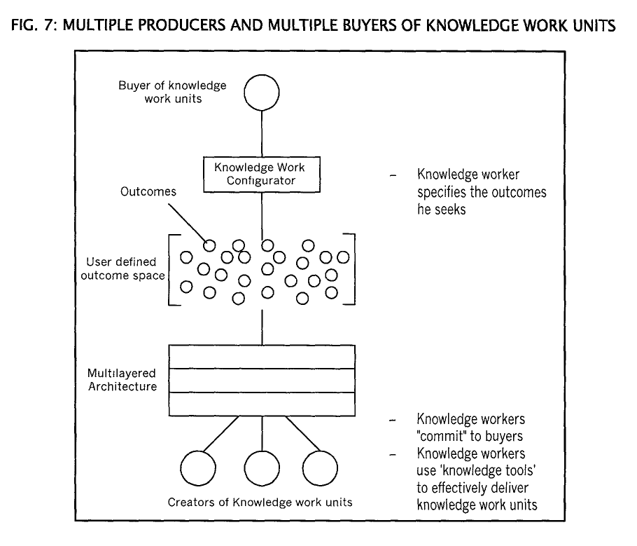

The unit for such knowledge work marketplace cannot be well-defined in product terms, however, the access intelligence technology offers a fresh approach that makes knowledge work marketplaces or distributed knowledge work environments possible, wherein a single document (which today would be made by a single professional), can be meaningfully configured by a high priced and experienced professional, on the basis of numerous inputs available not as part of a work flow, but as part of a marketplace, wherein multiple producers of that knowledge unit are available for choice, and multiple buyers are also available for multiple uses of the same knowledge work unit. (See FIG. 7).

The value of such a technology would be the ability to create global pools of talent or knowledge work resources who service multiple corporations in almost all repetitive or clearly defined knowledge tasks, thereby allowing the buying corporations or professionals to focus upon, and build on their core differentiating capabilities and unique knowledge, which helps configure these components together and buy out lower cost standardized knowledge work products on a “just-in-time” basis, from a global supply base.

At present there are enabling technology infrastructures which aim to improve workflows within corporations or processes. The present embodiment aims to go beyond, by allowing each knowledge worker to be both a buyer of knowledge work from which a unique solution can be configured an also a supplier of the knowledge work to multiple buyers of the same skills, competencies and of products configured and made available by the knowledge worker.

This embodiment has the following components: (1) Every knowledge worker being both a buyer and a seller of knowledge work, has an Access Portal, which is a “Knowledge Work Configurator”. This configurator enables the knowledge worker to specify the outcomes that he seeks, and thereby gain access to the relevant “outcome space” and the knowledge products that meet his specific outcomes within that space. (2) A transaction management infrastructure, which is an embodiment of the access intelligence engine in distributed infrastructure form, which comprises of a content hub architecture, which is layered on three dimensions (i) the task and delivery commitment layer (ii) the decision management layer (iii) the knowledge tools layer. These three layers are the core enablers of the system in terms of the efficient flow of knowledge products and, the management of their creation and delivery to specifications. Each of these infrastructures, are independent content hub based networks. The first layer makes available information and communication facilities that allow a knowledge worker to “commit” to accepting a buyer and committing to a specified delivery schedule. The second layer allows the system wide communication of relevant issues or concerns and also act as a trigger for optimal management of the delivery process. The third layer enables the knowledge worker to effectively deliver products to specification by making available all the relevant work tools, which collect, aggregate and package the needed information knowhow and learning inputs to effectively encounter and work through the outcome space, which the commitment made by the knowledge worker has defined. The above system thereby not only allows the pooling of knowledge work, but by making available the commitment specifications, the necessary management issues and the knowledge and learning inputs ensures that such a pooling is meaningful in terms of work product standards, and execution pathways.

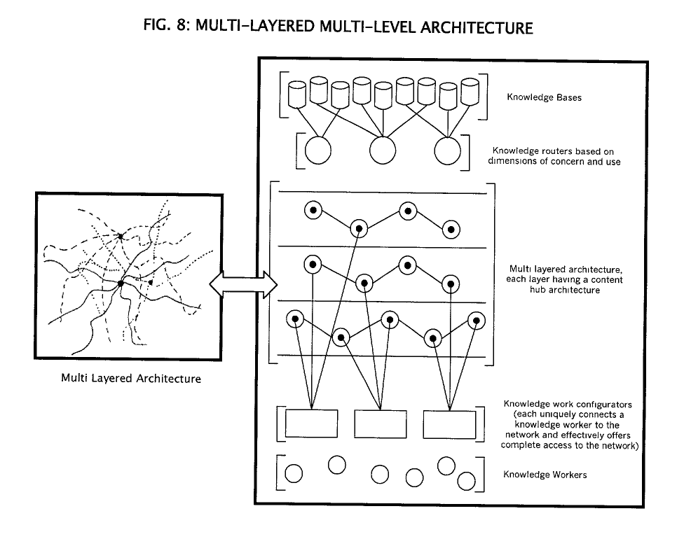

(See FIG. 8) The architecture of such a network is therefore a multi-layered architecture, with each layer having its own content hub architecture on different dimensions of concern. This multi-layered architecture further connects with relevant databases, on the basis of the tagging and information specification frameworks such as the UCKF (universal classification of knowledge framework) and relational taxonomies, which are discussed earlier in this patent application and other patent applications referred to earlier. Each knowledge worker connects to this multi layered communications network on the basis of the information specification architecture, and the UCKF which at this level allows each user to be specified as a seeker on the basis of the outcome sought, the context specified referring to the transaction layer, the concept referring to the content hub and the dimensions of concern contained therein, and the knowledge path being specified by the next level hierarchies being specified at the content hub level. This will also highlight an important and unique feature of this network. This network is highly flexible, modular, scalable and without a central controlling exchange. The core protocol for the entire network is a scalable version of the UCKF, wherein as the definition of seeker changes within and across layers within the network, the definitions of context, concept and knowledge path shift accordingly, thereby allowing any level of granularity in terms of moving from one knowledge object to the component parts. In practical terms, it implies that a complex knowledge project can be outsourced, to core vendors, who then can out source at the next level and so on, such that, the best resources worldwide can be identified, and their commitments bought into delivering the projects.

This multi-level multi-layered network is uniquely feasible, because of the notion of outcome hierarchies and outcome spaces, which are not hierarchical, but n-dimensional interwoven structures which can be mapped from particular role perspectives as described in the concurrently filed patent application entitled “Systems and Methods for Directed Knowledge Management Using the DISHA Platform” and networked on the dimensions of concern and content hub architecture described in concurrently filed patent application entitled “Systems and Methods for Development of An Interactive Document Cluster Network for Knowledge” and supported by the knowledge taxonomies and interactive document clusters described in the concurrently filed patent application entitled “Concept Mapping Based Knowledge Acquisition System and Methods” and concurrently filed patent application entitled “Systems and Methods for Development of An Interactive Document Cluster Network for Knowledge”, and a series of knowledge configurators and knowledge routers which are described in the concurrently filed patent application entitled “Systems and Methods for Visual Optimal Ordered Knowledge Learning Structures” and concurrently filed patent application entitled “Systems and Methods for Directed Knowledge Management Using the DISHA Platform”.

Such a network may be commercially managed by adding on additional transaction and management layers that enable bidding, security, transactional gateways for completion of monetary relationships etc. These may use currently available technologies mapped on to the above-described network.

### EXAMPLE 3

Sales Multiplier—Knowledge Customization System (KCS): An Embodiment of the Access Intelligence Technology:

With current information sources becoming larger and more complex, and the availability of an abundance of knowledge in different forms, it is increasingly important to the success of any organization to provide its knowledge workers, with customized meaningfully packaged knowledge, to enable them to meet the organizational deliverables efficiently. The KCS embodiment of the access intelligence technology, is a more basic manifestation of the technology, where the data already available in the organization, or to be made accessible to the user, is tagged on the basis of universal classification system, so that it may be retrieved relevantly and meaningfully reaggregated into customized packages on the fly, depending on the user need.

This embodiment comprises of at least three basic components: (1) a personal knowledge portal for the user; comprising of a presentation interface, a navigational grid that defines the “seeker” and a learning structure which defines “context”, said learning structure interacting with the knowledge taxonomy and delivering concepts to the retrieval engine (comprising of the knowledge use specification architecture from DISHA and the learning structures from Visual OOKs) (2) a domain specific retrieval engine (based on the knowledge routers in Visual OOKs) leading to (3) a knowledge server, comprising a universal classification knowledge tagged document base, based on the classification system. (See FIG. 1)

FIG. 1 also illustrates systems and methods for knowledge driven modus operandi and decision-making. These systems and methods comprise of various components including components for optimal data classification, components for relevant inquiry presentation and/or components for interactive delivery of knowledgeable solutions. This system may be deployed in organizations in the following manner: (1) the data already available in the organization or to be made accessible to the user is tagged on the basis of universal classification system. Alternatively, a pattern-seeking engine (also described in concurrently filed patent application entitled “Systems and Methods for Visual Optimal Ordered Knowledge Learning Structures”) may be used. These components will form part of the knowledge server which may serve the function of storing and allowing retrieval of appropriate documents that meet the retrieval criteria, (2) the users of the system which may vary in number, role and function (in terms of products, markets, clients, or geography) will each and collectively form part of a personal portal network with each individual having access to the user's own personal portal, (3) the domain context data will be associated with the retrieval engine mechanism which may be located either on the desktop/personal portal, or with the knowledge server or at an intermediate location which can allow some degree of local specification and document choices.

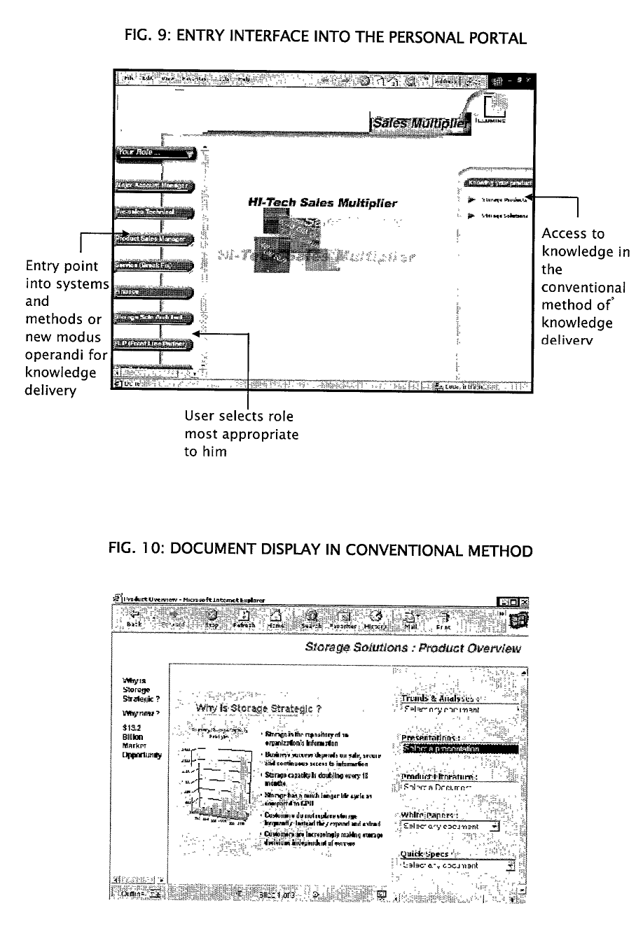

The user is presented with an entry screen into the personal knowledge portal of a ‘Sales Multiplier’ (See FIG. 9), said Sales Multiplier being a specific embodiment of the present invention. The screen offers to the user a choice of accessing knowledge in the conventional method of knowledge delivery—which is information centric. The screen also provides the entry point into systems and methods or new modus operandi for knowledge delivery by asking the user to choose which role defined on the screen is most relevant to that person's current action need or status.

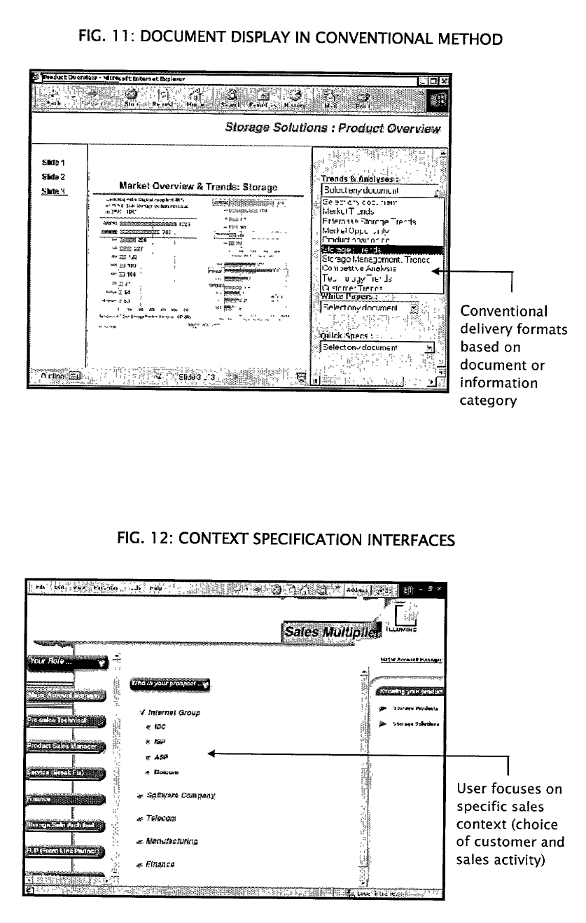

In case, the user chooses to access knowledge in the conventional method, this data is retrieved from the sales multiplier knowledge service provider (SM-KCS) by a conventional data retrieval engine. FIGS. 10 and 11 represent the display of data selected on the basis of type of document or information category, in the conventional delivery format.

When the user chooses to access knowledge through the systems and methods or new modus operandi for knowledge delivery, once he has chosen his appropriate role, he is asked to make a choice of the current customer prospect he/she is addressing. (See FIG. 12). In this screen the user selects one of the prospect choices presented. In other words, the user is asked to select and focus on the specific sales context he is currently involved in, which defines his specific “outcome”—the role, the choice of customer and the choice of a sales activity.

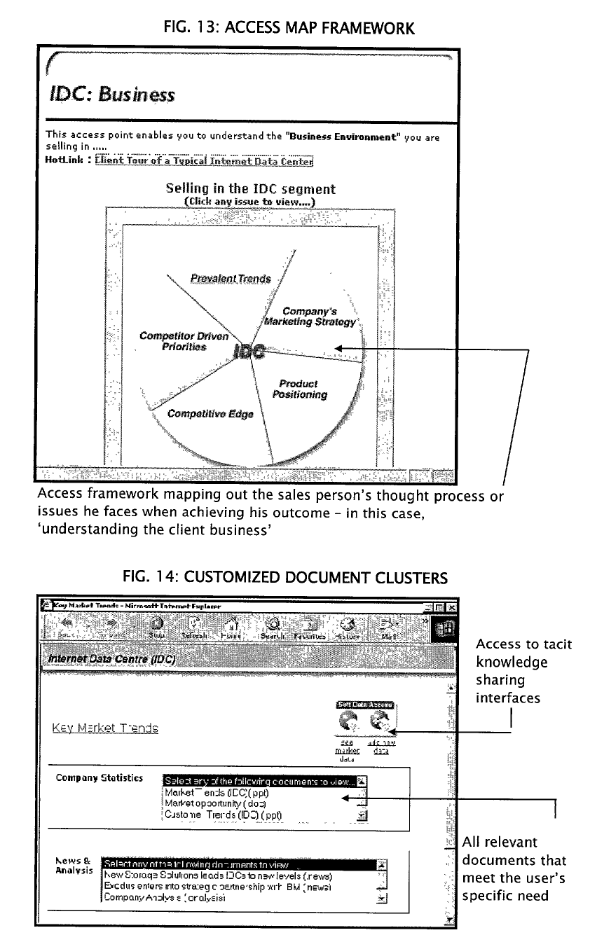

The user is then presented with a logical access map structure, presenting him with a set of options which essentially map out all the issues the sales person will face, and the information he will need to achieve his outcome. (See FIG. 13) In other words the options represent the users' thought process when trying to achieve his outcome, and not the underlying information. The personal portal uses the co-pending parent application entitled “Systems and Methods for directed knowledge management using the Disha Platform” (as described in concurrently filed patent application entitled “Systems and Methods for Directed Knowledge Management Using the Disha Platform”) which is incorporated herein, in its entirety.

On making the choice of query in the access map, the retrieval engine is able to carry out a directed search for all relevant documents that meet that specific customer situation and relevantly “packages” the knowledge into customized document clusters (See FIG. 14) through its deployment of the visual-OOKS platform (Visual-OOKS platform is described in detail in the concurrently filed patent application entitled “Systems and Methods for Visual Optimal Ordered Knowledge Learning Structures”). It does so, by (1) establishing the universal knowledge classification sequence most relevant to that outcome (2) presenting the request to the knowledge server (3) presenting the documents selected as a result of the Universal Classification Knowledge Framework (UCKF) matching process to the user in the required format displayed on the screen. According to the present embodiment of the invention, the KCS serves the function of enabling the document base or of the relevant knowledge universe to be searched out on the basis of the UCKF. This figure also offers the user access to soft or “tacit” knowledge fragments relevant to the knowledge requirement.

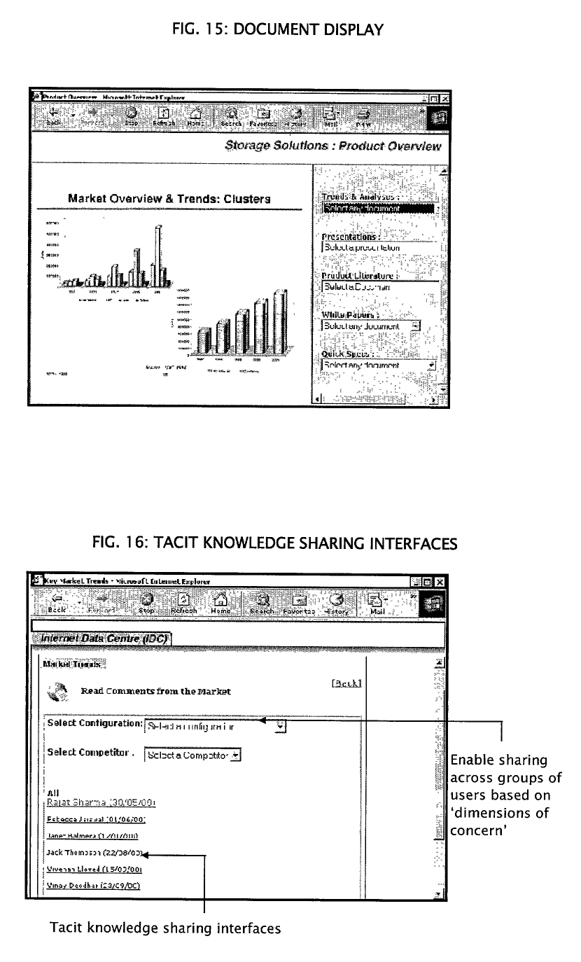

FIG. 15 illustrates one of the documents displayed as a result of the user choosing from the document set offered in FIG. 14.

The user can add new or access all relevant “tacit” data, through the tacit knowledge sharing interfaces (See FIG. 16). This tacit knowledge sharing platform, referred to as the Interactive Document Cluster (IDC), is described in detail in the concurrently filed patent application entitled “Systems and Methods for Development of an Interactive Document Cluster for Knowledge”. The problem used in FIG. 16 is described in detail in the co-pending parent application entitled “Systems and Methods for development of an Interactive Document Cluster for Knowledge” which is incorporated herein, in its entirety.

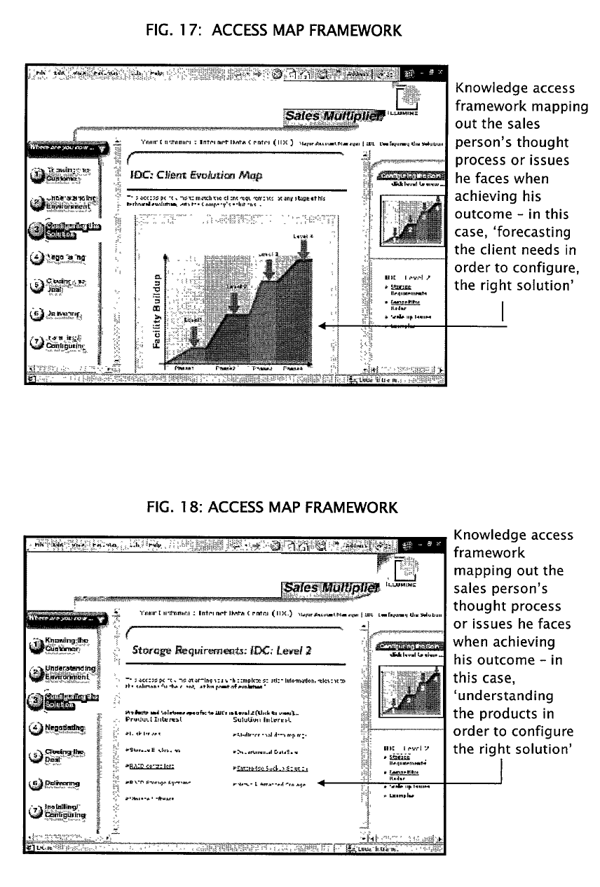

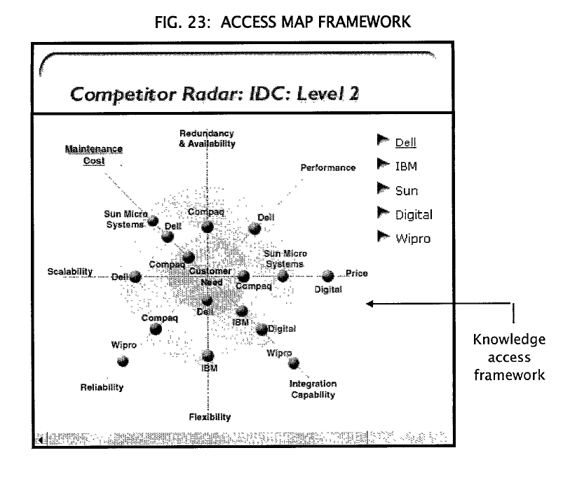

FIGS. 17, 18 and 23 illustrate different access frameworks to knowledge related to additional steps in the process. This is related to the choice of sales activity made in FIG. 12 above. The screens present an access framework, which constitutes a method of utilizing and ‘making sense’ of the knowledge that is contained on the subject. The access framework is a powerful paradigm, which describes a method of thinking about the problem currently being encountered and addressed by the user. The access framework does not describe the underlying data but is instead a mode of thinking about the data and can deeply influence the choice of documents and knowledge requirements specified by the seeker of knowledge.

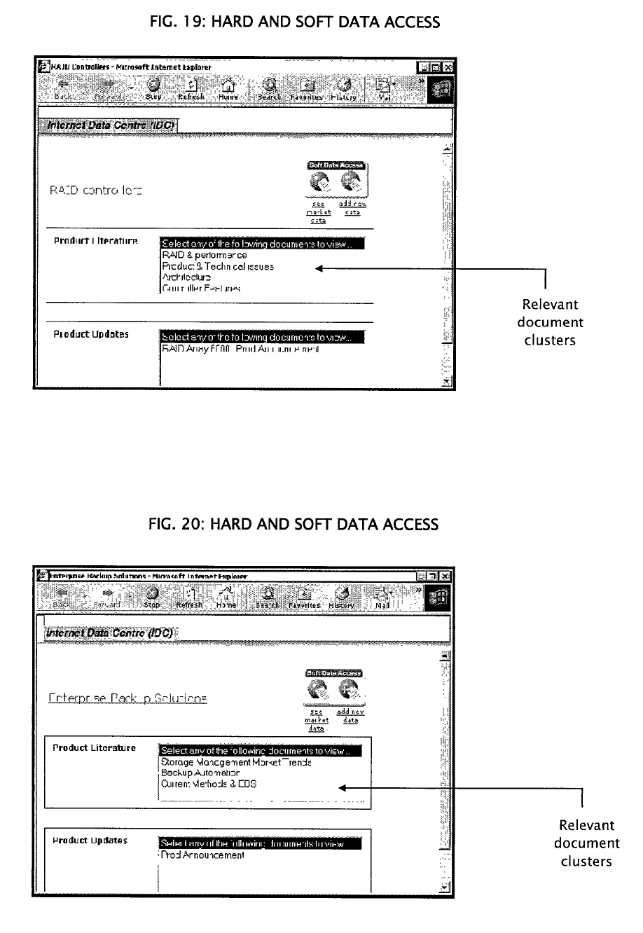

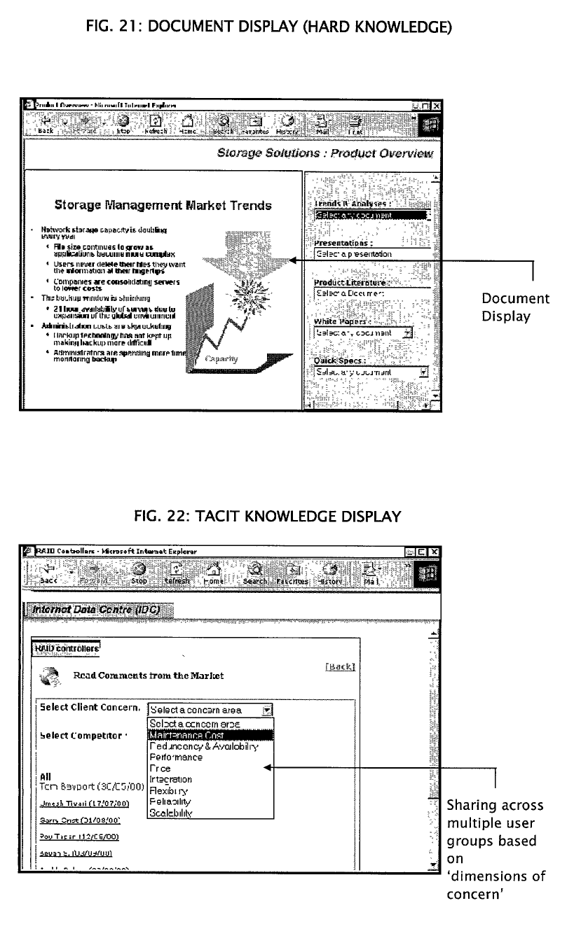

Under a new context, the user is presented with the relevant hard knowledge and soft data and the consequent displays of documents. (See FIGS. 19, 20, 21 and 22) These relate to FIGS. 14, 15 and 16 above in a different context.

The system is built on the premise that users may be able to make choices built on their current knowledge use/threshold; the retrieval mechanism may translate these choices into retrieval criteria based on the UCKF; and the knowledge servers may be centrally or conveniently located such that each user of the network gains access to a relevant but complete universe of knowledge for a particular context.

The present invention is not to be limited in scope by the embodiment disclosed in the example which is intended as an illustration of one aspect of the invention and any methods and devices which are functionally equivalent are within the scope of the invention. Indeed various modifications of the invention in addition to those shown and described herein will become apparent to those skilled in the art from the foregoing description. Specifications of all concurrently filed applications by applicant, and referenced above are incorporated in their entirety herein.

What is claimed is:

1. A system for retrieving relevant goal-optimal ordered knowledge, said system comprising:
a) a navigation and user directive system,
b) a set of knowledge structures and engines used to embed content and reaggregate content around the goal-oriented structures,
c) a framework for capturing and processing data across a goal-community, and
d) a framework to organize knowledge mining for a broader practice-community.

2. The system according to claim 2, wherein the system includes a set of access portals, an information addressing system or an access intelligence engine linking to the universe of information.

3. The system according to claim 1, wherein the knowledge structures and engines are used to tag data available to an organization on the basis of a universal classification system.

4. The system according to claim 1, wherein the framework to organize knowledge for a broader practice community, includes a network of personal portals enabling each user to have personal access.

5. A system for executing sales transactions, said system comprising of a) a personal knowledge portal, b) a domain specific retrieval engine, and c) a knowledge service provider.

6. The system according to claim 5, further comprising an access screen framework, said framework providing real intelligence, a set of relevant documents in response to a seeker's request.
